(19) United States
(12) Patent Application Publication
(10) Pub. No.: US 2018/0124018 A1
(43) Pub. Date: May 3, 2018

(54) COORDINATED APPLICATION FIREWALL

(71) Applicant: QUALCOMM Incorporated, San Diego, CA (US)

(72) Inventors: Gheorghe Cascaval, Palo Alto, CA (US); Hui Chao, San Jose, CA (US); Mihai Christodorescu, San Jose, CA (US); Drew Dean, Los Altos, CA (US); Dinakar Khurjati, Santa Clara, CA (US); Shuhua Ge, Fremont, CA (US); Hilmi Gunes Kayacik, San Jose, CA (US); Arun Raman, San Francisco, CA (US); Ahmet Salih Buyukkayhan, Boston, MA (US); Yuanwei Fang, Chicago, IL (US)

(21) Appl. No.: 15/388,934

(22) Filed: Dec. 22, 2016

Related U.S. Application Data
(60) Provisional application No. 62/416,085, filed on Nov. 1, 2016.

(51) Int. Cl. H04L 29/06

(52) U.S. Cl. CPC H04L 63/0254; H04L 63/1425; H04L 63/02

(57) ABSTRACT

Aspects may relate to a server comprising: an interface to receive a service request; and a processor coupled to the interface to receive the service request, the processor configured to: implement a firewall appliance for the service request; operate a first micro-security application to generate an anomaly alert for the service request; and operate a second micro-security application to receive the anomaly alert from the first micro-security application or from another server's micro-security application and to determine whether the service request corresponds to a non-benign behavior.

### CROSS REFERENCE TO RELATED APPLICATIONS

The present application claims priority to U.S. Provisional Patent Application No. 62/416,085 filed Nov. 1, 2016, entitled “Coordinated Application Firewall,” the content of which is hereby incorporated by reference in its entirety for all purposes.

### BACKGROUND

### Field

The present invention relates to a method, apparatus, and system for implementing a firewall appliance.

### Relevant Background

Network security firewalls monitor network traffic to identify anomalies and to prevent attacks. Currently, most firewall systems rely on rules and/or signatures to match packets in the network traffic to known patterns and/or signatures. Machine learning-based firewall systems are emerging as a way to identify anomalies for which no signatures have been defined or are readily available.

Once an anomaly is identified, a firewall system may classify it as one of an attack, a potential attack, or a benign anomaly. An attack may be blocked by the firewall system, the potential attack logged, and a benign anomaly let through. Sometimes a firewall system may detect an anomaly but need additional information that is not available in the network traffic to classify it. Further, enterprise computing and cloud computing are now moving toward utilizing micro-perimeters, which are customized firewalls that protect individual services.

### SUMMARY

Aspects may relate to a server comprising: an interface to receive a service request; and a processor coupled to the interface to receive the service request. The processor may be configured to: implement a firewall appliance for the service request; operate a first micro-security application to generate an anomaly alert for the service request; and operate a second micro-security application to receive the anomaly alert from the first micro-security application or from another server's micro-security application and to determine whether the service request corresponds to a non-benign behavior.

Aspects may relate to a server comprising: an interface to receive a service request; and a processor coupled to the interface to receive the service request. The processor may be configured to: implement a firewall appliance for the service request; operate a first micro-security application to generate an anomaly alert for the service request; and send the anomaly alert to a second micro-security application external to the server to determine whether the service request corresponds to a non-benign behavior.

Aspects may relate to a server comprising: means for implementing a firewall appliance for a service request; means for operating a first micro-security application to generate an anomaly alert for the service request; and means for operating a second micro-security application to receive the anomaly alert from the first micro-security application or from another server's micro-security application and to determine whether the service request corresponds to a non-benign behavior.

Aspects may relate to a method comprising: implementing a firewall appliance for a service request; operating a first micro-security application to generate an anomaly alert for the service request; and operating a second micro-security application to receive the anomaly alert from the first micro-security application or from another micro-security application and to determine whether the service request corresponds to a non-benign behavior.

### BRIEF DESCRIPTION OF THE DRAWINGS

FIG. 1 is a diagram of a system in which embodiments may be practiced.

FIG. 2 is a diagram illustrating an example coordinated firewall appliance.

FIG. 3 is a diagram illustrating an example environment.

FIG. 4 is a diagram illustrating an example sequence of operations of a coordinated firewall appliance.

FIG. 5 is diagram illustrating an example sequence of operations of a coordinated firewall appliance.

FIG. 6 is a flowchart illustrating an example method for implementing a firewall appliance.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

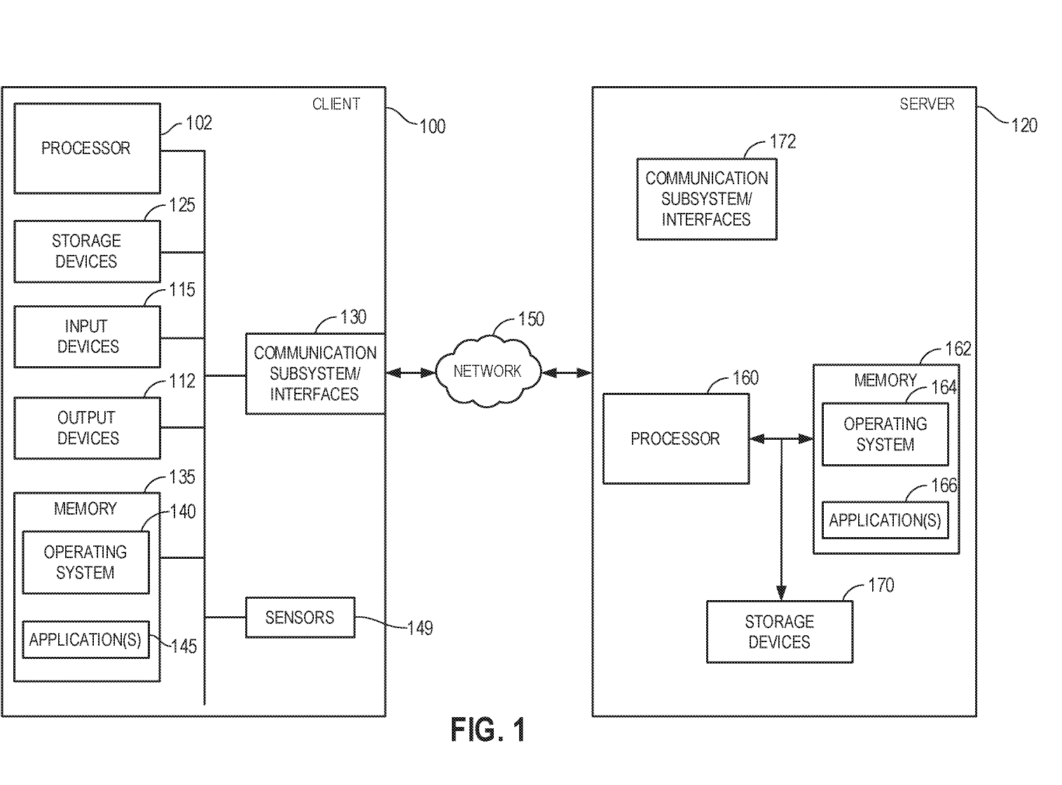

With reference to FIG. 1, as an example, device 100 may be in communication with a server 120, via a network 150 (e.g., wireless, wired, or a combination thereof). As an example, device 100 may comprise hardware elements that can be electrically coupled via a bus (or may otherwise be in communication, as appropriate). The hardware elements may include one or more processors 102, including without limitation one or more general-purpose processors and/or one or more special-purpose processors (such as secure processors, cryptoprocessors, digital signal processing chips, graphics acceleration processors, and/or the like); one or more input devices 115 (e.g., keyboard, keypad, touchscreen, buttons, microphone, camera, etc.); and one or more output devices 112—such as a display device (e.g., a screen), speaker, sound device, etc. Additionally, device 100 may include a wide variety of sensors 149. Sensors may include: a clock, an ambient light sensor (ALS), a biometric sensor, an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, or any type of sensor.

Device 100 may further include (and/or be in communication with) one or more non-transitory storage devices or non-transitory memories 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communication subsystems and/or interfaces 130 may permit data to be exchanged with a server 120 through an appropriate network 150 (wireless and/or wired).

In some embodiments, device 100 may further comprise a working memory 135, which can include a RAM or ROM device, as described above. Device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a device 100 to perform one or more operations in accordance with the described methods, according to embodiments described herein.

A set of these instructions and/or code may be stored on a non-transitory computer-readable storage medium, such as the storage device(s) 125, described above, or other memory 135 locations. In some cases, the storage medium might be incorporated within a computer system, such as device 100. In other embodiments, the storage medium might be separate from the devices (e.g., a removable medium, such as a compact disc), and/or provided in an installation package, such that the storage medium can be used to program, configure, and/or adapt a device with the instructions/code stored thereon. These instructions might take the form of executable code, which is executable by device 100 and/or might take the form of source and/or installable code, which, upon compilation and/or installation on device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other devices such as network input/output devices may be employed.

As previously described, device 100 may be any type of device, computer, smartphone, tablet, cellular telephone, watch, wearable device, Internet of Things (IoT) device, or any type of computing device that can communicate with a server 120 via a wired and/or wireless network 150.

It should be appreciated that server 120 may be a device having at least a processor 160, a memory 162 with one or more applications 166, an interface/communication subsystem 172, as well as other hardware and software components, to implement operations. Aspects to be described hereafter may relate to a method performed by server 120 for the implementation of a coordinated firewall appliance.

In some embodiments, server 120 may comprise a working memory 162, which can include a RAM or ROM device. Server 120 may include firmware elements, software elements, shown as being currently located within the working memory 162, including an operating system 164, applications 166, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (e.g., a server) (and/or a processor within a device); in an aspect, then, such code and/or instructions can be used to configure and/or adapt a server 120 to perform one or more operations in accordance with the described methods, according to embodiments described herein.

A set of these instructions and/or code may be stored on a non-transitory computer-readable storage medium, such as the storage device(s) 170, or other memory 162 locations. In some cases, the storage medium might be incorporated within a computer system, such as server 120. In other embodiments, the storage medium might be separate from the devices (e.g., a removable medium, such as a compact disc), and/or provided in an installation package, such that the storage medium can be used to program, configure, and/or adapt a device with the instructions/code stored thereon. These instructions might take the form of executable code, which is executable by server 120 and/or might take the form of source and/or installable code, which, upon compilation and/or installation on server 120 (e.g., using any of a variety of generally available compilers, installation programs, compression/decompression utilities, etc.), then takes the form of executable code.

Embodiments of the disclosure are related to a method, apparatus, and system for implementing a coordinated firewall appliance comprising a plurality of micro-security applications (μSAs). Hereinafter the terms micro-firewall, micro-perimeter firewall, or micro-security application may be used interchangeably.

A server-implemented client-facing service may comprise one or more micro-service applications. Examples of micro-service applications may include web service applications, database service applications, file service applications, version control service applications, etc. A micro-service application may answer requests from one or more other micro-service applications. Each micro-service application may be individually protected by a micro-security application. Therefore, for a plurality of micro-service applications of a service, a plurality of associated micro-security applications may be configured with the knowledge about the relationships between the micro-service applications. Whenever two micro-service applications communicate with each other, their respective associated micro-security applications may also exchange information with each other. In a service path, a micro-service application that sends a request may be referred to as being upstream, and a micro-service application that receives a request downstream. The upstream micro-service application is associated with an upstream micro-security application, and the downstream micro-service application is associated with a downstream micro-security application. One or more micro-service applications and associated micro-security applications may reside on a single physical server (e.g., server 120) or across a plurality of suitably connected physical servers.

Upstream micro-security applications in the service path may detect anomalies in the network traffic and communicate the detected anomalies to downstream micro-security applications. Additional information relating to the pattern triggering the anomaly detection may also be communicated from upstream micro-security applications to downstream micro-security applications. Based on the information received from the upstream micro-security applications, downstream micro-security applications may tailor the monitoring and confirm the anomalies as being associated with either attacks or non-attacks. Downstream micro-security applications may communicate the classification of the anomalies back to the upstream micro-security applications.

Micro-service applications and the micro-security applications that protect them may work across a plurality of client-facing services. The collective operations of micro-security applications that are associated with a particular client-facing service may be seen as forming a logical security appliance (LSA). LSAs may be formed by one or more of the following means: a) manual configuration by system administrators (e.g., a system administrator may configure each micro-security application with the knowledge about its upstream and downstream micro-security applications), b) dynamic service discovery (e.g., each client-facing service may register itself at a service-discovery component, and each micro-security application may determine upstream connections by monitoring the identity of micro-service applications that query about its own micro-service application at the service-discovery component), or c) on-demand LSA formation (e.g., each time a micro-service application receives a request from a new source, its associated micro-security application may attempt to establish an upstream connection with the micro-security application associated with the source). Therefore, each micro-security application may be part of one or more LSAs, mirroring how the micro-service application it protects is part of one or more services.

In one embodiment, an upstream micro-security application may notify a downstream micro-security application of an observed anomaly, putting the downstream micro-security application on the lookout for anomalous activities. In particular, the upstream micro-security application may observe an anomalous request and temporarily block it from reaching its micro-service application. For each downstream micro-service application, the upstream micro-security application may notify the associated downstream micro-security application with details about the observed anomaly and its possible manifestation at the downstream micro-security application. Optionally, before notifying the downstream micro-security applications, the upstream micro-security application may need to analyze the anomaly to determine downstream micro-service applications that may be affected by it. After notifying the downstream micro-security applications, the upstream micro-security application may wait for acknowledgements (ACKs) from all notified downstream micro-security applications. Once all the expected ACKs have been received, the upstream micro-security application may release the anomalous request to its micro-service application. Thereafter, the upstream micro-service application may issue requests to downstream micro-service applications based on the anomalous request. Each downstream micro-security application that encounters a request related to the anomalous request may analyze the request in the context of the anomaly data received from the upstream micro-security application and determine whether the request represents a non-benign behavior such as an attack from a malicious party. If an attack or a non-benign behavior is detected by a downstream micro-security application, the micro-security application may drop the downstream request and notify the upstream micro-security application.

In one embodiment, a downstream micro-security application may inquire at an upstream micro-security application about additional contextual information about an anomaly observed at the downstream micro-security application, thereby allowing the downstream micro-security application to make a more accurate decision as to whether the anomaly should be classified as an attack or a non-benign behavior.

Furthermore, a micro-security application may send notifications of anomalies to and/or request additional information about current or previous anomalies from another micro-security application within the LSA. This may be especially useful if the two micro-security application protect micro-service applications that share an upstream or downstream micro-service application. Therefore, micro-security application in an LSA may be in a peer-to-peer relationship, a hierarchical relationship, or a hybrid of both.

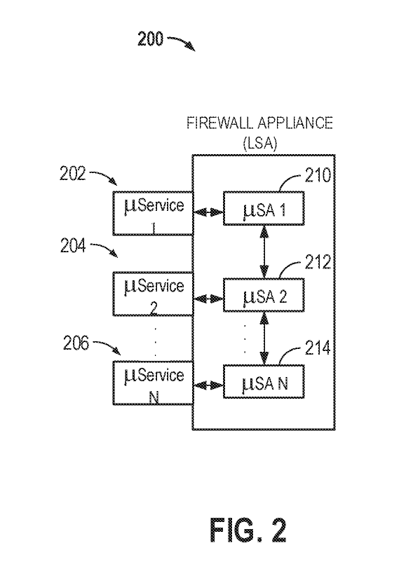

Referring to FIG. 2, a diagram illustrating an example coordinated firewall appliance 200 is shown. The firewall appliance 200 comprises a plurality of micro-security applications, which comprise μSA 1 210, μSA 2 212, . . . μSA N 214, etc. The micro-security applications μSA 1 210, μSA 2 212, . . . μSA N 214, etc. protect micro-service applications μService 1 202, μService 2 204, . . . μService N 206, etc., respectively. As a single client-facing service may comprise the micro-service applications μService 1 202, μService 2 204, . . . μService N 206, etc., the micro-security applications μSA 1 210, μSA 2 212, . . . μSA N 214, etc. may collectively form an LSA.

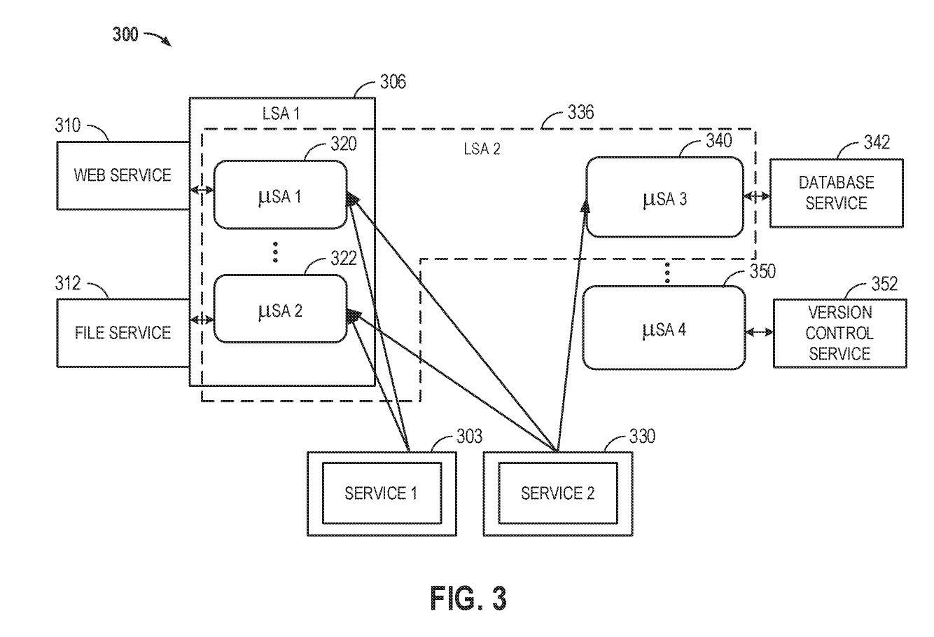

Referring to FIG. 3, a diagram illustrating an example environment 300 is shown. Four micro-service applications are present in environment 300: a web service 310, a file service 312, a database service 342, and a version control service 352. The four micro-service applications are protected by micro-security applications μSA 1 320, μSA 2 322, μSA 3 340, and μSA 4 350, respectively. The client-facing Service 1 303 is implemented with two micro-service applications: the web service 310 and the file service 312. Therefore, the associated micro-security applications μSA 1 320 and μSA 2 322 may form an LSA, i.e., LSA 1 306. Similarly, the client-facing Service 2 330 is implemented with three micro-service applications: the web service 310, the file service 312, and the database 342. Therefore, the associated micro-security applications μSA 1 320, μSA 2 322, and μSA 3 340 may form an LSA, i.e., LSA 2 336. It should be appreciated that a service request may be intercepted as an incoming request from a remote server or a service request may be intercepted as an outgoing request from a remote server. Therefore, in one embodiment, a pair of service requests including the incoming request from the remote server and the outgoing request from the remote server are associated via a causal relationship. Further, as has been previously described, one or more micro-service applications and associated micro-security applications may reside on a single physical server (e.g., server 120) or may reside across a plurality of suitably connected servers. Each server may therefore have suitable interfaces, processors, memories, and storage device, etc., to implement the micro-service applications and associated micro-security applications.

When multiple LSAs coexist over a set of micro-service applications and their associated micro-security applications (e.g., when a set of micro-service applications host multiple services simultaneously), sometimes the particular LSA that should handle a particular request may need to be determined. This may be achieved in various ways. For example, the LSA information may be provided by the upstream micro-security applications, if any. The determination may also be based on an analysis of the header and content of the request. Rules may be supplied to help determine the appropriate LSA. The rules can be created by a system administrator (e.g., “use LSA 2 if the ‘Host’ HTTP header is mail.google.com”). In another embodiment, the rules may be inferred using machine learning techniques. In particular, signatures useful for assigning requests to LSAs may be derived in a simulated/learning phase based on correlations between incoming and outgoing requests using machine learning techniques. The correlations may be based on either the timing information (e.g., an outgoing request that follows an incoming request within a short time window is assumed to be correlated with the latter) or event tracing (e.g., software hooked into a service may reveal request correlations). Therefore, it should be appreciated that a service request may be intercepted as an incoming request from a remote server or a service request may be intercepted as an outgoing request from a remote server, and, in one embodiment, a pair of service requests including the incoming request from the remote server and the outgoing request from the remote server are associated via a causal relationship.

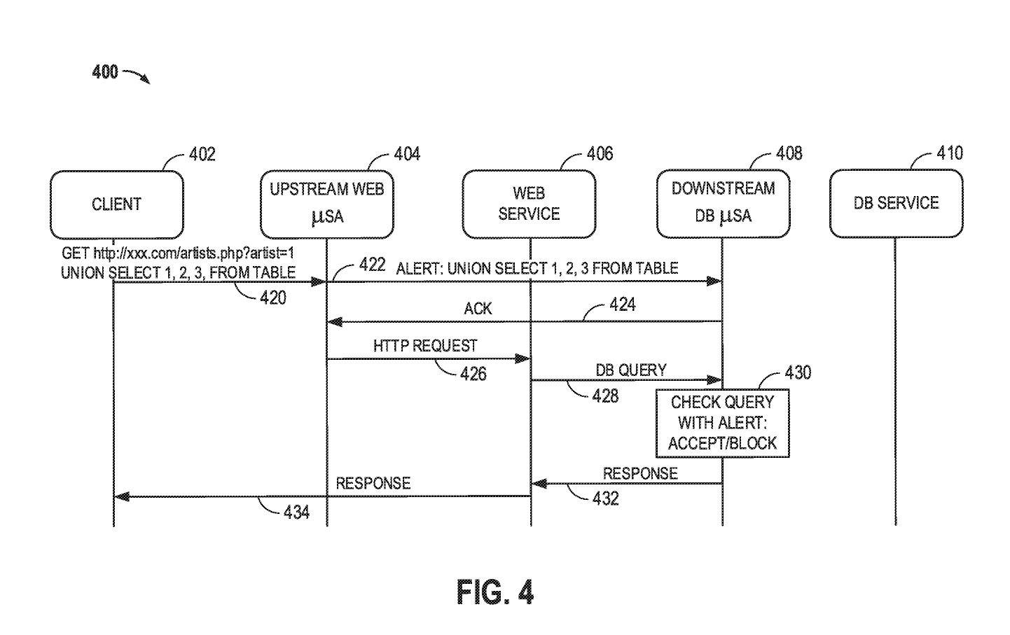

Referring to FIG. 4, a diagram illustrating an example sequence 400 of operations of a coordinated firewall appliance is shown. The client 402 may send a request 420 (e.g., “GET http://xxx.com/artists.php?artist=-1 UNION SELECT 1, 2, 3, FROM TABLE”) to the micro-service application web service 406. The μSA 404 protecting the web service 406 and being the upstream μSA in the sequence 400 may find the request 420 to be anomalous and temporarily block it from reaching the web service 406. The upstream μSA 404 may determine that the request 420 would cause the web service 406 to send a request to the micro-service application database service 410. Therefore, the upstream μSA 404 may notify 422 the downstream μSA 408 that protects the database service 410 of the anomalous request 420 (e.g., “ALERT: UNION SELECT 1, 2, 3 FROM TABLE”). The upstream μSA 404 may wait for the ACK 424 from the downstream μSA 408. After receiving the ACK 424, the upstream μSA 404 may release the request 420 as an HTTP (Hypertext Transfer Protocol) request 426 to the web service 406. In response to the HTTP request 426, the web service may issue a database query 428 that is destined for the database service 410. The downstream μSA 408 may analyze the database query 428 in the context of the notification 422 received from the upstream μSA 404 and determine 430 whether the database query 428 and thus the anomalous request 420 represent an attack or a non-benign behavior.

At block 430, the downstream μSA 408 may either release or drop the database query 428 based on the determination. The downstream μSA 408 may notify the upstream μSA 404 about its determination and the action it has taken. In the event the downstream μSA 408 drops the database query 428, it may also notify the web service 406 via a response 432. And the web service 406 may accordingly return a response 434 to the client 402.

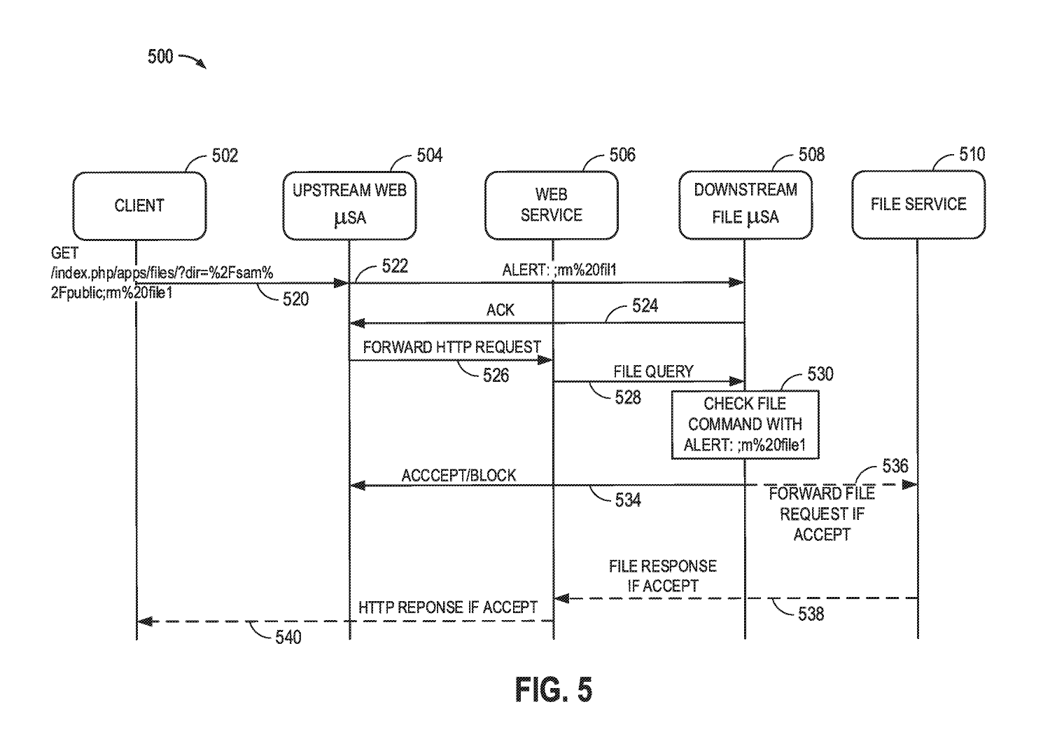

Referring to FIG. 5, a diagram illustrating an example sequence 500 of operations of a coordinated firewall appliance is shown. The client 502 may send a request 520 (e.g., “GET/index.php/apps/files/?dir=%2Fsam%2Fpublic;rm%20file1”) to the micro-service application web service 506. The μSA 504 protecting the web service 506 and being the upstream μSA in the sequence 500 may find the request 520 to be anomalous and temporarily block it from reaching the web service 506. The upstream μSA 504 may determine that the request 520 would cause the web service 506 to send a request to the micro-service application file service 510. Therefore, the upstream μSA 504 may notify 522 the downstream μSA 508 that protects the file service 510 of the anomalous request 520 (e.g., “ALERT: ;rm%20file1”). The upstream μSA 504 may wait for the ACK 524 from the downstream μSA 508. After receiving the ACK 524, the upstream μSA 504 may release the request 520 as an HTTP request 526 to the web service 506. In response to the HTTP request 526, the web service may issue a file query 528 that is destined for the file service 510. The downstream μSA 508 may analyze the file query 528 in the context of the notification 522 received from the upstream μSA 504 and determine 530 whether the file query 528 and thus the anomalous request 520 represents an attack or a non-benign behavior.

The downstream μSA 508 may either release or drop the file query 528 based on the determination. The downstream μSA 508 may notify 534 the upstream μSA 504 about its determination and the action it has taken. In the event the downstream μSA 508 releases 536 the file query 528, the file service 510 may return to the web service 506 with a file response 538. And the web service 506 may accordingly return an HTTP response 540 to the client 502.

As has been described previously, and particularly, in FIGS. 4 and 5, a micro-security application may determine or identify that a request may be anomalous and may generate and transmit an anomaly alert downstream. As an example, the upstream micro-security application may reason about the anomalousness of a request, and may produce a corresponding anomaly score, by analyzing the structure of the request and comparing it against the characteristics of a known-benign set of previous requests. Analyzing the structure of the request means computing one or more metrics, including the length of the request or any of its component parts, the statistical distribution of the bytes of the request, the relative arrival time of the request in relation to previous requests, and the numerical value of the various request component parts. In addition to such metrics, the micro-security application may use knowledge of specific domains to further refine the anomaly score, including determining how much of the request (if any) or of its component parts consists of code in common programming languages or communication protocols of interest such as SQL, Bash, or SMB. Various examples have been provided with respect to FIGS. 4 and 5, but it should be appreciated that various methods of determining or identifying possible anomalous requests and generating anomaly alerts to be transmitted, in various types of languages, protocols, domains, networks, etc., may be utilized.

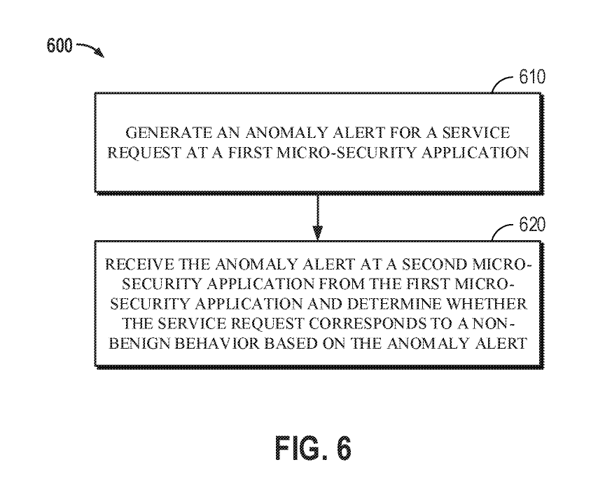

Referring to FIG. 6, a flowchart illustrating an example method 600 for implementing a firewall appliance is shown. At block 610, an anomaly alert may be generated for a service request at a first micro-security application. At block 620, the anomaly alert may be received at a second micro-security application from the first micro-security application or from another server's micro-security application and whether the service request corresponds to an attack or a non-benign behavior may be determined based on the anomaly alert. The service request may be received from a remote client, and may cause data to be requested from a web service, a file service, a database service, or a control service. If the second micro-security application determines that the service request corresponds to an attack or a non-benign behavior, the second micro-security application may transmit a response to the first micro-security application that the service request corresponds to an attack or a non-benign behavior, and may block the service request. If the second micro-security application determines that the service request does not correspond to an attack or a non-benign behavior, the second micro-security application may transmit a response to the first micro-security application that the service request does not correspond to an attack or a non-benign behavior, and may allow the service request to pass through. Various examples of process 600 have been previously described in detail (e.g., FIGS. 2-6).

It should be appreciated that aspects of the previously described processes may be implemented in conjunction with the execution of instructions by a processor (e.g., processor 102, 160) of devices (e.g., client 100, server 120), as previously described. Particularly, circuitry of the devices, including but not limited to processors, may operate under the control of a program, routine, or the execution of instructions to execute methods or processes in accordance with embodiments described (e.g., the processes and functions of FIGS. 2-6). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A server comprising:
an interface to receive a service request; and
a processor coupled to the interface to receive the service request, the processor configured to:
implement a firewall appliance for the service request;
operate a first micro-security application to generate an anomaly alert for the service request; and
operate a second micro-security application to receive the anomaly alert from the first micro-security application or from another server's micro-security application and to determine whether the service request corresponds to a non-benign behavior.

2. The server of claim 1, wherein, if the second micro-security application determines that the service request corresponds to a non-benign behavior, the second micro-security application transmits a response to the first micro-security application that the service request corresponds to a non-benign behavior.

3. The server of claim 2, wherein, if the second micro-security application determines that the service request corresponds to a non-benign behavior, the second micro-security application blocks the service request.

4. The server of claim 1, wherein, if the second micro-security application determines that the service request does not correspond to a non-benign behavior, the second micro-security application transmits a response to the first micro-security application that the service request does not correspond to a non-benign behavior.

5. The server of claim 4, wherein, if the second micro-security application determines that the service request does not correspond to a non-benign behavior, the second micro-security application allows the service request to pass through.

6. The server of claim 1, wherein, a service request is received from a remote client.

7. The server of claim 6, wherein, a service request causes data to be requested from at least one of a web service, a file service, a database service, or a control service.

8. The server of claim 1, wherein, a service request is intercepted as an incoming request from a remote server.

9. The server of claim 8, wherein, a service request is intercepted as an outgoing request from the remote server.

10. The server of claim 9, wherein, a pair of service requests including the incoming request from the remote server and the outgoing request from the remote server are associated via a causal relationship.

11. A method comprising:
implementing a firewall appliance for a service request;
operating a first micro-security application to generate an anomaly alert for the service request; and
operating a second micro-security application to receive the anomaly alert from the first micro-security application or from another micro-security application and to determine whether the service request corresponds to a non-benign behavior.

12. The method of claim 11, wherein, if the second micro-security application determines that the service request corresponds to a non-benign behavior, the second micro-security application transmits a response to the first micro-security application that the service request corresponds to a non-benign behavior.

13. The method of claim 12, wherein, if the second micro-security application determines that the service request corresponds to a non-benign behavior, the second micro-security application blocks the service request.

14. The method of claim 11, wherein, if the second micro-security application determines that the service request does not correspond to a non-benign behavior, the second micro-security application transmits a response to the first micro-security application that the service request does not correspond to a non-benign behavior.

15. The method of claim 14, wherein, if the second micro-security application determines that the service request does not correspond to a non-benign behavior, the second micro-security application allows the service request to pass through.

16. The method of claim 11, wherein, a service request is received from a remote client.

17. The method of claim 16, wherein, a service request causes data to be requested from at least one of a web service, a file service, a database service, or a control service.

18. A server comprising:
an interface to receive a service request; and
a processor coupled to the interface to receive the service request, the processor configured to:
implement a firewall appliance for the service request;
operate a first micro-security application to generate an anomaly alert for the service request; and
send the anomaly alert to a second micro-security application external to the server to determine whether the service request corresponds to a non-benign behavior.

19. The server of claim 18, wherein, the first micro-security application receives a response from the second micro-security application that the service request corresponds to a non-benign behavior when the second micro-security application determines that the service request corresponds to a non-benign behavior.

20. The server of claim 19, wherein, the first micro-security application receives a block notification from the second micro-security application when the second micro-security application determines that the service request corresponds to a non-benign behavior and blocks the service request.

21. The server of claim 18, wherein, the first micro-security application receives a response from the second micro-security application that the service request does not correspond to a non-benign behavior when the second micro-security application determines that the service request does not correspond to a non-benign behavior.

22. The server of claim 21, wherein, the first micro-security application receives an accept notification from the second micro-security application when the second micro-security application determines that the service request does not correspond to a non-benign behavior and allows the service request.

23. The server of claim 18, wherein, a service request is received from a remote client.

24. The server of claim 18, wherein, a service request causes data to be requested from at least one of a web service, a file service, a database service, or a control service.

25. A server comprising:
means for implementing a firewall appliance for a service request;
means for operating a first micro-security application to generate an anomaly alert for the service request; and
means for operating a second micro-security application to receive the anomaly alert from the first micro-security application or from another server's micro-security application and to determine whether the service request corresponds to a non-benign behavior.

26. The server of claim 25, wherein, if the second micro-security application determines that the service request corresponds to a non-benign behavior, the second micro-security application further comprises means for transmitting a response to the first micro-security application that the service request corresponds to a non-benign behavior.

27. The server of claim 26, wherein, if the second micro-security application determines that the service request corresponds to a non-benign behavior, the second micro-security application further comprises means for blocking the service request.

28. The server of claim 25, wherein, if the second micro-security application determines that the service request does not correspond to a non-benign behavior, the second micro-security application further comprises means for transmitting a response to the first micro-security application that the service request does not correspond to a non-benign behavior.

29. The server of claim 28, wherein, if the second micro-security application determines that the service request does not correspond to a non-benign behavior, the second micro-security application further comprises means for allowing the service request to pass through.

30. The server of claim 22, wherein, a service request is received from a remote client.
